(19) United States
(12) Patent Application Publication
(10) Pub. No.: US 2014/0123853 A1
(43) Pub. Date: May 8, 2014

(54) OFFLINE WATER WASH SYSTEM FOR INLET FILTERS AND FILTER HOUSE

(71) Applicant: BHA Altair, LLC, Franklin, TN (US)

(72) Inventors: Bhalchandra Arun Desai, SE Smyrna, GA (US); Sanji Ekanayake, Mableton, GA (US); Alston Ilford Scipio, Mableton, GA (US)

(73) Assignee: BHA Altair, LLC, Franklin, TN (US)

(21) Appl. No.: 13/671,575

(22) Filed: Nov. 8, 2012

(51) Int. Cl. B01D 46/00

(52) U.S. Cl. CPC B01D 46/0082; B01D 46/0068
USPC 95/280; 96/229; 95/281

(57) ABSTRACT

A filter house and cleaning system arrangement for a turbine system and an associated method. The arrangement includes a filter house and filter elements within the filter house. The arrangement includes nozzles that spray a fluid on the filter elements to provide cleaning of the filter elements. The nozzles have structure that permits the nozzles to move within the filter house to adjust where on the filter elements the fluid is sprayed. The arrangement includes a detection device configured to detect a level of cleanliness and provide an output that indicates the level of cleanliness.

### BACKGROUND OF THE INVENTION

1. Field of the Invention

The present application relates generally to gas turbine engines and more particularly relates to a filter washing system and method for use with a gas turbine air inlet and the like.

2. Discussion of the Prior Art

Air entering a turbine compressor inlet and similar devices should be filtered before compression or other use. Impure inlet air laden with dirt, debris, dust particles, salt, and other contaminants damage the compressor blades, plug cooling passages, and damage other types of power generation equipment via corrosion, erosion, fouling, and the like. Such damage may reduce the life expectancy and the overall performance of the generation equipment. To avoid this problem, the inlet air may pass through one or more filters to remove the entrained contaminants.

The air filters, however, may have a relatively short life span due to accumulation of the dirt, debris, and other types of contaminants. This accumulation also may raise the pressure drop across the filter element. Raising the pressure drop reduces the overall airflow into the compressor, power output and the efficiency of the gas turbine engine. As such, the filter elements typically may be replaced when the pressure drop reaches the point in which the gas turbine operator deems the loss of machine efficiency exceeds the availability impact and costs associated with the replacing the filters. However, frequent filter replacement may result in high maintenance costs to the gas turbine end user in terms of labor and filters as well as the loss of revenue due to engine downtime and unavailability. Performing online filter replacement may result in premature wear of gas turbine compressor components and may be prohibited by safety regulations in some locations.

To avoid the costs and problems associated with filter replacement, the filter elements are sometimes cleaned to remove the accumulation of the dirt, debris, and other types of contaminants. Known cleaning techniques include manually washing filter elements or providing a reverse blast of compressed air to the filter elements that creates a shock wave which knocks off the accumulated dirt, debris, and other contaminants. However, manual washing requires labor and is time consuming and compressed air cleaning techniques are sometimes not effective in cleaning dirt and debris located at the top of the filter elements.

There is thus a need for an insitu filter element cleaning system that can effectively and efficiently remove the accumulation of dirt, debris, and other contaminants from the filter elements in an inlet air filter system.

### BRIEF DESCRIPTION OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect, the present invention provides a filter house and cleaning system arrangement for a turbine system. The arrangement includes a filter house, and filter elements and inlet cooling equipment within the filter house. The arrangement includes nozzles that spray a fluid on the filter elements to provide cleaning of the filter elements. The nozzles have structure that permits the nozzles to move within the filter house to adjust where on the filter elements the fluid is sprayed. The arrangement includes a detection device configured to detect a level of cleanliness and provide an output that indicates the level of cleanliness.

In accordance with another aspect, the present invention provides a method for washing filter elements within a filter house for a turbine system. The method includes the steps of providing nozzles and spraying a fluid from the nozzles onto the filter elements. The method includes moving the nozzles within the filter house to adjust where on the filter elements the fluid is sprayed. The method includes detecting water leakage and carryover in the clean side. The method includes detecting a level of cleanliness and providing an output that indicates the level of cleanliness. In one specific example, the method includes utilization of a microprocessor based system with preprogrammed control logic to improve the effectiveness of washing.

### BRIEF DESCRIPTION OF THE DRAWINGS

These and other aspects are better understood when the following detailed description is read with reference to the accompanying drawings, in which:

FIG. 1 is a schematic view of an example filter house and cleaning system arrangement for an example turbine system;

FIG. 2 is a schematic view of some example details of the filter house and cleaning system arrangement;

FIG. 3 schematically illustrates extension and retraction of a spray nozzle in an example embodiment of the cleaning system;

FIG. 4 schematically illustrates rotation of a spray nozzle in an example embodiment of the cleaning system;

FIG. 5 is a flow chart representing a beginning of an example cleaning sequence that may be performed using the cleaning system;

FIG. 6 is a flow chart representing a chemical or normal wash cycle that may be performed during the example cleaning sequence; and

FIG. 7 is a flow chart representing a rinse sequence that is performed during the example cleaning sequence.

### DETAILED DESCRIPTION OF THE INVENTION

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

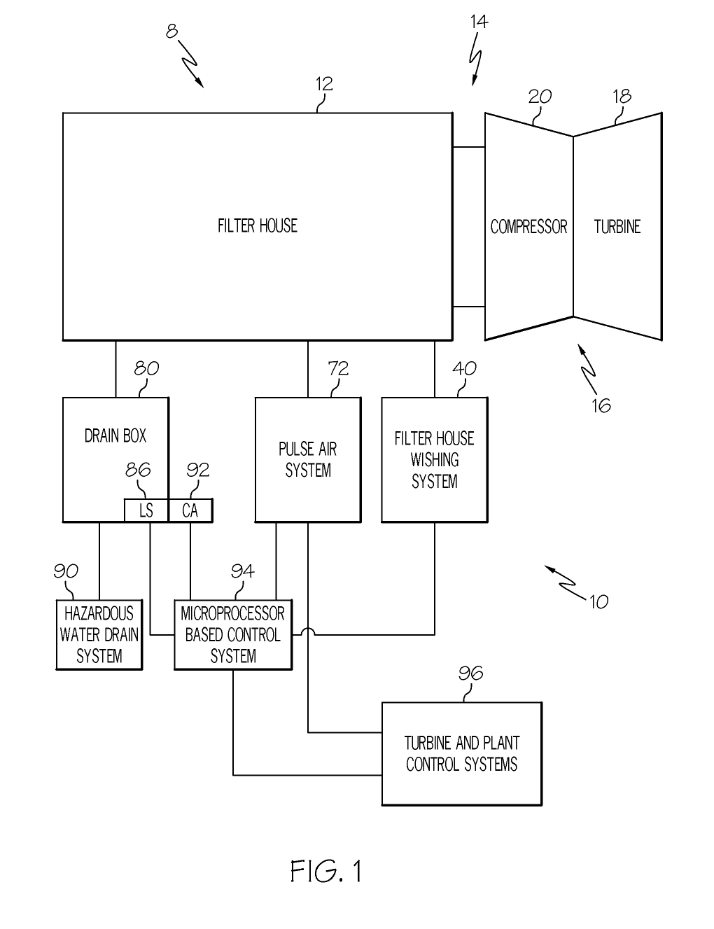

FIG. 1 schematically shows an example filter house and cleaning system arrangement 8 in accordance with an aspect of the present invention. The arrangement 8 includes a cleaning system 10 for a filter house 12 of an example turbine system 14. The shown example turbine system 14 includes a turbine engine 16 with a turbine 18 and a compressor 20. The compressor 20 compresses an incoming flow of air for the turbine engine 16. The mechanical work produced in the turbine 18 drives the compressor 20 along with external loads such as an electrical generator or the like. The turbine engine 16 may use natural gas, various types of syngas, and other types of fuels. The turbine engine 16 may have other configurations and may have types of components. Multiple turbine engines, other types of turbines, and other types of power generation may be used herein together. Of course, the turbine system 14 need not be a specific limitation upon the present invention.

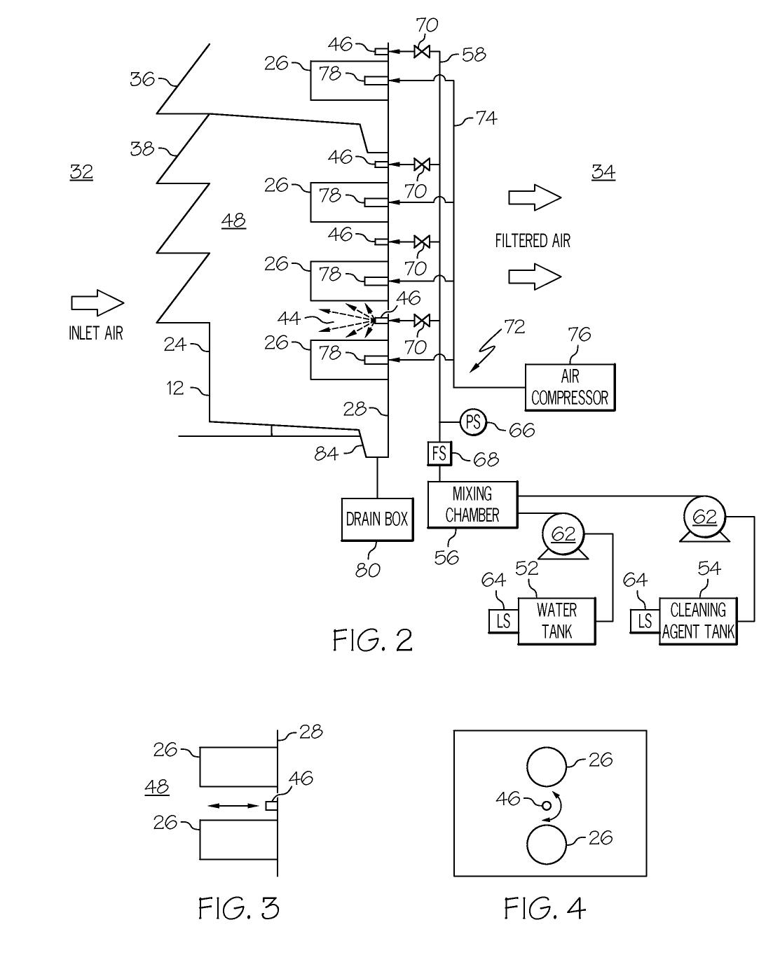

The filter house 12 may be positioned adjacent to an inlet of the compressor 20, or other type of air inlet system, to filter inlet air. As schematically shown in FIG. 2, the filter house 12 may be bounded by a housing 24. The filter house 12 includes a number of filter elements 26. The filter elements 26 may have a variety of constructions and/or configurations, such as being pleated or non-pleated. As another possible variant, the filter elements 26 may include a hydrophobic and/or an oleophobic filter media therein. The filter media may be a web of synthetic fibers. The filter media may include PFTE (Polytetrafluoroethylene), ePFTE (Expanded Polytetrafluoroethylene), and similar types of materials. Examples of filter elements with a hydrophobic and/or a oleophobic filter media include a F9 MH filter sold by General Electric Company of Schenectady, N.Y., a Duravee HXL 98 Filter sold by AAF International of Louisville, Ky., and a D-Salt filter sold by Donaldson Company, Inc. of Minneapolis, Minn., and similar types of filter elements and hydrophobic or oleophobic filter media.

The filter elements 26 may extend from a wall 28 of the housing 24 or some other surface within the housing 24. The filter elements 26 may be arranged in the form of a grid and each of the filter elements 26 may be inclined to promote fluid drainage. The filter house 12 is configured such that inlet air enters the filter house 12 and passes through the filter elements 26 before exiting the filter house 12 and entering the inlet of the turbine engine 16. As the inlet air passes through the filter elements 26, the filter media traps dirt, debris, dust particles, salt, or other contaminants within the inlet air. The space upstream of the filter elements 26 thus becomes the dirty side 32 of the filter elements 26 while the space downstream of the filter elements 26 becomes the clean side 34 of the filter elements 26.

The filter house 12 may be divided into multiple decks. For instance, as shown in FIG. 2, the filter house 12 may be divided into a top/upper deck 36 and a bottom/lower deck 38. Each deck may include one or more filter elements. Moreover, although two filter decks are shown in FIG. 2, there may be other example filter houses which are divided into more than two decks. Additionally, the filter house 12 may be divided into multiple filter banks. For example, the filter house 12 may be configured such that the air passes through a pre-filter bank followed by a final filter bank. Moreover, the filter house 12 may be configured to include more than two filter banks. It is to be appreciated that the construction/configuration of the filters, the multiple decks, and/or the multiple banks may be varied and need not be specific limitations upon the present invention.

Turning to the cleaning system 10, the cleaning system 10 includes a washing system 40. As schematically shown in FIG. 2, the washing system 40 can spray a washing fluid 44 into the filter house 12 and onto the filter elements 26 to remove accumulated dirt, debris, and other contaminants from the filter elements 26. The washing fluid 44 may be chilled below ambient temperature, at ambient temperature, or above ambient temperature. The washing fluid 44 may be water, a chemical solution comprising water and a cleaning agent, or another cleaning fluid. The water of the washing fluid 44 may be clean, demineralized water or pH neutral water. The cleaning agent may be a known detergent or some other cleaning product. The washing fluid 44 composition may depend on the area of the filter house 12 being sprayed, the contaminants present in the environment, the media type of the filter elements 26 in use, and/or other factors.

Also shown in FIG. 2, the washing system 40 includes a number of spray nozzles 46 to direct the washing fluid 44 within the filter house 12. Any number of spray nozzles 46 may be used. The spray nozzles 46 may be positioned between the filter elements 26 and along the same wall 28 from which the filter elements 26 extend. However, the spray nozzles 46 may be located elsewhere. For example, the spray nozzles 46 may be located across from, above, or below the filter elements 26. The spray nozzles 46 may also be attached to other surfaces within the housing 24.

Each spray nozzle 46 may be moveable within the filter housing 24. For example, each spray nozzle 46 may extend into or retract from the interior 48 of the filter housing 24 as schematically represented in FIG. 3 via a double arrowhead. Each spray nozzle may also be constructed/configured to rotate as schematically represented in FIG. 4 via an arrow headed arc. It is contemplated that each nozzle may be constructed/configured to have other, different movements. Such movements allow a single spray nozzle to direct washing fluid 44 toward various locations along one or more filter elements 26. Moreover, the spray nozzles 46 may be oriented to direct the washing fluid 44 toward other portions of the filter house 12 such as the filter housing walls, bird screens, and trays.

Returning to FIG. 2, the washing system 40 may include a water tank 52 to store the washing fluid 44. If the washing system 40 uses a chemical solution, the washing system 40 may also include a separate cleaning agent tank 54 to store the cleaning agent. A separate mixing chamber 56 can be provided to mix a ratio of the water and cleaning agent within. The washing system 40 may include washing fluid distribution piping 58 to provide fluid communication between the spray nozzles 46, water tank 52, and mixing chamber 56. Moreover, the washing system 40 may include pumps 62 to distribute/transfer the water from the tank 52 and the cleaning agent from the tank 54, respectively, into the mixing chamber 56. In turn the mixed washing fluid 44 from mixing chamber 56 is delivered to the spray nozzles 46 via the washing fluid distribution piping 58.

It is to be appreciated that the relative amounts of the cleaning agent and the water being supplied to the mixing chamber 56 at any particular time can be varied via varied operation of the two pumps 62. As such, various operation scenarios are possible. For example, it is possible to initially only supply water to the mixing chamber 56. As such, only water is delivered to the spray nozzles 46 via the washing fluid distribution piping 58. Subsequently it is possible to supply both cleaning agent and the water to the mixing chamber 56. As such the mixed cleaning agent and water delivered to the spray nozzles 46 via the washing fluid distribution piping 58. At a further subsequent time, it is possible to again only supply water to the mixing chamber 56. As such, only water is delivered to the spray nozzles 46 via the washing fluid distribution piping 58. So within the presented example a sequence of water only, water and cleaning agent, and water only is provided.

The washing system 40 may also be equipped with one or more sensors. For example, as shown in FIG. 2, the water and cleaning agent tanks 52, 54 may include level sensors 64 to detect how much water and cleaning agent is available for use. The washing system 40 may also include one or more pressure sensors 66 or flow sensors 68 in the washing fluid distribution piping 58 to ensure that the pump 62 is operating correctly and that the spray nozzles 46 are receiving sufficient washing fluid 44.

Within one example embodiment, the washing system 40 will preferably wash the filter elements 26 in sequence from the top deck 36 to the bottom deck 38 to ensure that the lower filter elements 26 will not be washed first and then be contaminated with runoff from the filter elements 26 located above. For example, the spray nozzles 46 may be moved/oriented to direct washing fluid 44 toward the top deck 36 filter elements 26 first. The spray nozzles 46 may then be moved/oriented to direct washing fluid 44 towards the lower filter elements 26. Additionally, the washing fluid distribution piping 58 may include control members, such as solenoid valves 70, which can be opened or closed to control which spray nozzles 46 receive washing fluid 44. As such, control members (e.g., solenoid valves 70) can dictate which spray nozzles 46 will spray washing fluid 44 and thus which filter elements 26 will be washed. Accordingly, the washing system 40 can wash the filter elements 26 in a top deck 36 to bottom deck 38 sequence through movement of the spray nozzles 46, control of the solenoid valves 70, or some combination thereof. Moreover, the washing system 40 may be capable of other sequences. For example, the washing system 40 may wash the filter elements 26 from pre filter bank to final filter bank or vice versa. The washing system 40 may also wash the filter elements 26 simultaneously in no particular sequence. The washing system will also have the capability to wash any other installed components inside the filter house such as chiller coils etc.

Returning to FIG. 1, the cleaning system 10 may also include a pulse air system 72 to deliver compressed air to the filter elements 26. As shown in FIG. 2, the pulse air system 72 may include an air piping system 74 which transfers compressed air from an air compressor 76 to a number of air nozzles 78. Preferably, the air nozzles 78 will direct the compressed air to the filter elements 26 in a direction that is reverse to the direction of travel for the inlet air. For example, as shown in FIG. 2, compressed air is applied to the clean side 34 of the filter elements 26. The compressed air then travels through the filter elements 26 to the dirty side 32 of filter elements 26.

A blast of compressed air may be used to create a shock wave which can knock accumulated dirt, debris, or other contaminants off of the filter elements 26. Additionally, the compressed air may also be used to dry the filter elements 26. For example, after the washing system 40 sprays the filter elements 26, the pulse air system 72 can be activated to remove any residual cleaning fluid that remains on the filter elements 26. In another embodiment, the pulse air could be heated to supply warm air to dry the filter elements.

Similar to the washing system 40, the pulse air system 72 can spray the air nozzles 78 in a sequence such that the compressed air is applied to the filter elements 26 from the top deck 36 to the bottom deck 38. However, the air nozzles 78 may be sprayed simultaneously or in some alternative sequence.

The cleaning system 10 may further include a drain box 80 in fluid communication with the filter house 12. As shown in FIG. 2, the example filter house 12 includes a runoff drain 84 that receives runoff fluid from the washing system 40. The drain box 80 can be connected into the runoff drain 84 to collect the runoff fluid. A drain valve may be located between the drain box 80 and the runoff drain 84 to permit or limit fluid communication between the drain box 80 and the runoff drain 84. Additionally, a floor of the filter house 12 may be sloped to assist in directing the runoff fluid towards the runoff drain 84 and into the drain box 80.

The drain box 80 may be equipped with a flow sensor and/or a level sensor 86 to ensure that there is not a buildup of washing fluid 44 in the filter house 12 due to blockage, as shown in FIG. 1. Additionally, the drain box 80 may be tied into a hazardous waste drain system 90 so that the runoff fluid can be safely collected and disposed of. There may also be additional valves located between the drain box 80 and the hazardous waste drain system 90 to permit or limit fluid communication between the drain box 80 and the hazardous waste drain system 90.

If the filter house 12 is divided into multiple decks, each deck may have its own runoff drain, sloped floor, drain valve, or combination thereof. If multiple runoff drains are present, there may be a separate drain box for each runoff drain. Alternatively, each runoff drain may tie into the same drain box or there may be one runoff drain that collects runoff fluid from the remaining runoff drains and feeds the runoff fluid into a drain box.

The cleaning system 10 may also include a detection device to detect the quality of filter cleaning achieved and provide an output that indicates the level of cleanliness. For example, FIG. 1 schematically shows that a conductivity analyzer 92 may be used to detect the number of residual contaminants that are present in the runoff fluid that collects in the drain box 80. A high level of residual contaminants present in the runoff fluid will indicate that the filter elements 26 are in need of further cleaning. Although the detection device of the present embodiment analyzes runoff water in the drain box 80, other locations may be analyzed to determine the quality of the filter cleaning achieved. For example, the detection device could analyze runoff water in the runoff drain 84 or in the piping which runs between the runoff drain 84, drain box 80, and hazardous waste drain system 90.

Additionally, other devices or methods other than a conductivity analyzer 92 may be used to detect the quality of filter cleaning achieved. For example, pH indicators or clarity/turbidity sensors may be used or a visual inspection of the filter elements 26 or runoff fluid may be performed.

As shown in FIG. 1, the cleaning system 10 may also include a microprocessor based control system 94 as a means for controlling the cleaning system 10. One or more elements of the cleaning system 10 may be in communication with the control system 94. For example, the control system 94 may be in communication with the pulse air system 72, the washing system 40, drain valves, level sensors 64 and 86, flow sensors 68, conductivity analyzers 92, or any combination thereof. Additionally, the control system 94 may include one or more alarms or timers. For example, the control system 94 may include an alarm that will activate when there is an insufficient amount of water available in the water tank 52 for a cleaning sequence. Also, the control system 94 may include a timer so that the washing system 40 will only spray washing fluid 44 into the filter house 12 for a limited time.

The control system 94 can be interfaced with turbine control systems and other plant control systems 96. The control system 94 may also include an interface or panel to allow plant personnel to interact with the control system 94 and operate the cleaning system 10. Accordingly, the control system 94 can provide the ability to operate one or more elements of the cleaning system 10 in a cleaning sequence 100.

The cleaning system 10 described above can be operated manually, automatically, or in some combination thereof. In one specific example, the cleaning system 10 will be operated while the turbine engine 16 is shut down or on turning gear. However, there may be elements of the cleaning system 10 which operate while the turbine engine 16 is in operation.

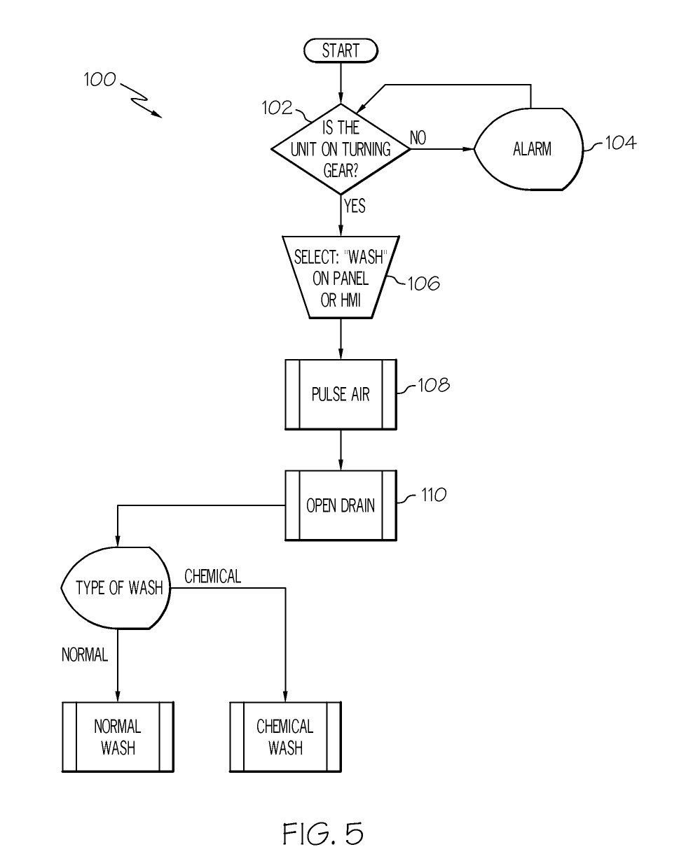

FIGS. 5-7 provide flowcharts which together illustrate an example cleaning sequence 100 that may be performed using the cleaning system 10 described above. As shown in FIG. 5, the example cleaning sequence 100 begins with the step 102 of determining if the turbine engine 16 is on turning gear (e.g., a low-speed operation). If the turbine engine 16 is in operation, an alarm 104 within the control system 94 will activate and the sequence will not proceed forward. However, if the turbine engine 16 is on turning gear, an operator may then start the wash cycle in step 106. It should be appreciated that although the present example requires the turbine engine 16 to be on turning gear before starting the wash cycle, there may be other example sequences in which the wash cycle is allowed to start while the turbine is shut down or in operation.

In step 106, the operator starts the wash cycle by selecting “WASH” on an interface or panel. The operator may also have the option to select which type of wash cycle will be performed. For example, the operator may select a chemical wash that uses a solution of water and a cleaning agent as its washing fluid 44. Alternatively, the operator may select a normal wash which will only use water as its cleaning fluid.

If multiple filter banks are present, an operator may also have an option to select which banks are to be washed. For example, an operator may have the option to select “ALL”, “PRE” or “FINAL” (“ALL”—both filter banks, “PRE”—pre filter bank, “FINAL”—final filter bank). If less than all of the filter banks are selected for washing, the steps hereinafter will only pertain to the filter banks that were selected for washing.

The example cleaning sequence 100 further includes step 108, wherein the pulse air system 72 delivers pulse air to the filter house 12 to dislodge large particles and agitate any caked material adhering to the outside of the filter elements 26. The drain valve is then opened in step 110 to permit fluid communication between the runoff drain 84 and drain box 80. Although the example sequence illustrated in FIG. 5 shows that the drain valve is opened after the delivery of pulse air, the drain valve may be opened during or even before the delivery of pulse air. In fact, the drain valve may be opened at any point before cleaning fluid is sprayed into the filter house 12.

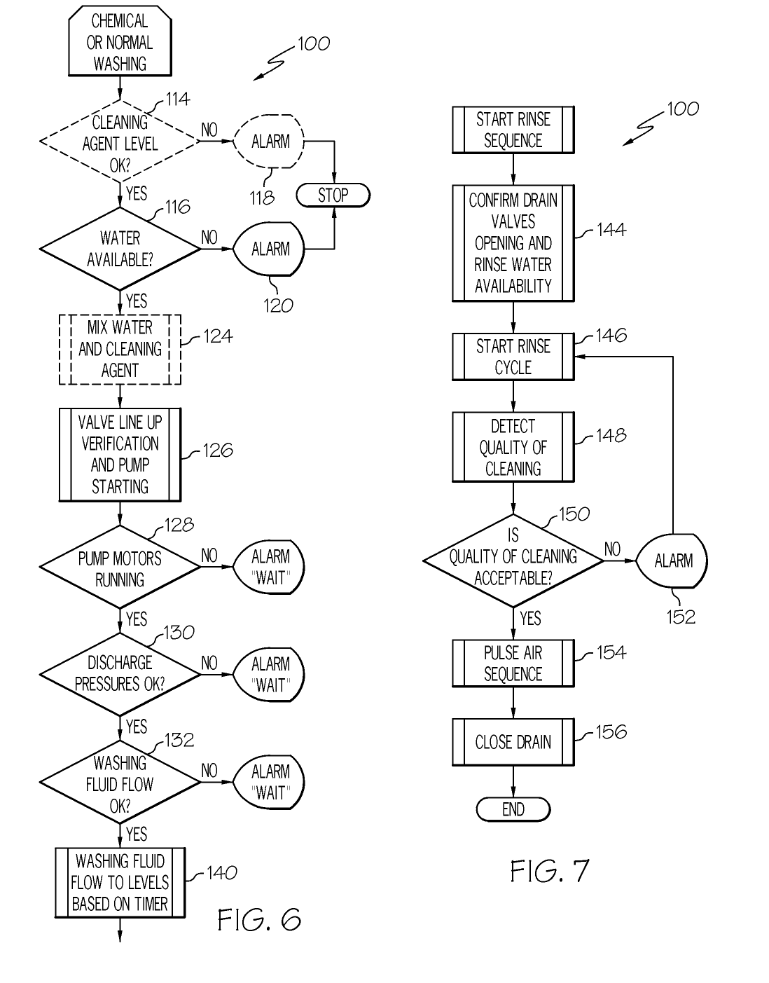

The subsequent steps in the example cleaning sequence 100 vary depending on the type of wash cycle that is selected by the operator. FIG. 6 shows the chemical or normal wash cycle for the example cleaning sequence 100.

The chemical wash cycle begins with the step 114 of determining if there is a sufficient amount of cleaning agent available for the chemical wash cycle. The chemical wash cycle also includes the step 116 of determining if there is a sufficient amount of water available for the chemical wash cycle. These levels may be determined with level sensors 64 in the water tank 52 and cleaning agent tank 54, as shown in FIG. 2. If either amount is insufficient, an alarm 118, 120 will activate within the control system 94 and the sequence will stop. Although the flowchart in FIG. 6 shows that the cleaning agent level is determined first, it should be appreciated that the water level may be determined before the cleaning agent level.

The chemical wash cycle further includes step 124, wherein a ratio of water and the cleaning agent is mixed. The ratio may depend on the area of the filter house 12 being sprayed, the contaminants present in the environment, the media type of the filter elements 26 in use, and/or other factors. Once the ratio of the mixture is imputed—in manual mode-, the control system 94 will activate the pumps 62 in step 126 and verify that the proper valves are open or closed in the washing fluid distribution piping 58 for washing. In automatic mode the system will activate the pumps 62 and create the wash solution based on the programmed predetermined ratio and verify that the proper valves are open or closed in the washing fluid distribution piping 58 for washing. The operator would also be free to choose the mixing proportion or the controller will determine optimum ratio based on predetermined parameters and feedback from the system.

Once the pump 62 is activated, the cleaning system 10 will begin spraying the solution into the filter house 12. The control system 94 will verify that the pump motors are running and that the discharge pressures and flow of the solution are sufficient, as represented by steps 128, 130, and 132. If the discharge pressures or flow of the solution are insufficient or if the pump motors are not running, an alarm will activate. Otherwise, the cleaning system 10 will spray the solution into the filter house 12 on a timer-based sequence, as represented by step 140. For example, the control system 94 can sequence the spraying so that the filter elements 26 are washed from the top deck 36 to the bottom deck 38. The control system 94 can use timers to control how long each deck is sprayed with the solution.

For the normal wash cycle, water may be used as a washing fluid 44 without adding a cleaning agent. As such, the step 114 of determining the level of cleaning agent is unnecessary. Instead, normal wash cycle begins with the step 116 of determining if there is a sufficient amount of water available for the normal wash cycle. If the amount of water is insufficient, an alarm 120 will activate within the control system 94 and the sequence will stop. If the amount is sufficient, the control system 94 will activate the pump 62 and verify valve positions in step 126.

Once the pump 62 is activated, the cleaning system 10 will begin spraying water into the filter house 12. The control system 94 will verify that the pump motors are running and that the discharge pressures and flow of the water are sufficient, as represented by steps 128, 130, and 132. If the discharge pressures or flow of the water are insufficient or if the pump motors are not running, an alarm will activate. Otherwise, the cleaning system 10 will spray the water into the filter house 12 on a timer-based sequence, as represented by step 140. For example, the control system 94 can sequence the spraying so that the filter elements 26 are washed from the top deck 36 to the bottom deck 38. The control system 94 may use timers to control how long each deck is sprayed with the water.

FIG. 7 shows the rinse sequence portion of the example cleaning sequence 100. The rinse sequence follows the wash cycle and begins with the step 144 of confirming that the drain valve is opened and that there is a sufficient amount of rinse water available. The rinse water may come from the same water tank 52 as the water that is used for the wash cycle or the rinse water may come from a different source. Once it is confirmed that the drain valve is opened and there is sufficient amount of rinse water available, the rinse cycle will start in step 146. During the rinse cycle, rinse water is sprayed through the spray nozzles 46 into the filter house 12. Similar to the wash cycle, the cleaning system 10 can spray the rinse water into the filter house 12 on a timer-based sequence. For example, the control system 94 can sequence the spraying so that the filter elements 26 are rinsed from the top deck 36 to the bottom deck 38. The control system 94 can use timers to control how long each deck is sprayed with the rinse water.

Once the rinse cycle is complete, the cleaning system 10 will detect the quality of cleaning in step 148 and determine if the quality of cleaning is acceptable in step 150. This can be accomplished using a detection device such as a conductivity analyzer or turbidity sensor 92. The conductivity analyzer 92 can detect the quality of cleaning and provide an output to the control system 94 which indicates the level of cleanliness. If the quality of cleaning is unacceptable, an alarm 152 within the control system 94 will activate and the rinse cycle can either be manually or automatically reactivated. Steps 148 and 150 are then repeated to determine if the rinse cycle will be reactivated any further.

Once the quality of cleaning is acceptable, the pulse air system 72 will activate in step 154 to dry out the filter elements 26 and remove any residual water. The drain valve will then close to prohibit fluid communication between the runoff drain 84 and drain box 80, as represented by step 156. The example cleaning sequence 100 is then complete.

A continuous check is also carried out to detect any water leakage or carryover on the clean side. Water boxes are provided and the cleaning cycle is stopped.

It should be apparent that the foregoing relates only to certain embodiments of the present application and that numerous changes and modifications may be made herein by one of ordinary skill in the art without departing from the general spirit and scope of the invention as defined by the following claims and equivalents thereof.

1-20. (canceled)

21. A filter house and cleaning system arrangement for a turbine system, the arrangement including:
a filter house;
filter elements within the filter house;
nozzles that spray a fluid on the filter elements to provide cleaning of the filter elements, the nozzles having structure that permits the nozzles to move within the filter house to adjust where on the filter elements the fluid is sprayed; and
a detection device configured to detect a level of cleanliness and provide an output that indicates the level of cleanliness.

22. The arrangement in accordance with claim 21, wherein the filter house has an interior and the nozzles have structure that permits the nozzles to extend into or retract from the interior.

23. The arrangement in accordance with claim 21, wherein the nozzles have structure that permits the nozzles to rotate.

24. The arrangement in accordance with claim 21, further including a pulse air system, the pulse air system configured to deliver compressed air to the filter elements.

25. The arrangement in accordance with claim 21, wherein the filter house has a drain that is configured to receive the fluid that is sprayed onto the filter elements.

26. The arrangement in accordance with claim 25, wherein the filter house has a sloped floor that is configured to direct the fluid towards the drain.

27. The arrangement in accordance with claim 25, wherein the drain is in fluid communication with a drain box that collects the fluid.

28. The arrangement in accordance with claim 27, wherein the detection device is configured to detect the level of cleanliness in the fluid that collects in the drain box.

29. The arrangement in accordance with claim 27, wherein the content of the fluid can be varied.

30. A method for washing filter elements within a filter house and cleaning system arrangement for a turbine system, the method including the steps of:
providing nozzles;
spraying a cleaning fluid from the nozzles onto the filter elements;
moving the nozzles within the filter house to adjust where on the filter elements the fluid is sprayed;
detecting a level of cleanliness and providing an output that indicates the level of cleanliness; and
using the output to determine whether to continue the spraying.

31. The method of claim 30, further including the step of providing a pulse of compressed air to the filter elements before spraying the fluid.

32. The method of claim 30, further including the step of providing a pulse of compressed air to the filter elements after spraying the fluid.

33. The method of claim 30, further including the step of spraying a solution onto the filter element, the solution comprising water and a cleaning agent.

34. The method of claim 33, further including the step of spraying rinse water onto the filter elements after the solution is sprayed.

35. The method of claim 30, further including the step of providing a runoff drain that configured to receive the fluid that is sprayed onto the filter elements.

36. The method of claim 35, wherein the fluid is received by the runoff drain and then sent to a drain box.

37. The method of claim 36, further including the step of detecting the level of cleanliness in the fluid that collects in the drain box.

38. The method of claim 36, wherein the filter elements includes a top filter element and a bottom filter element located below the top filter element, the step of spraying a fluid from the nozzles onto the filter elements includes the steps of:
I) spraying a first amount of fluid onto the top filter element and then spraying a second amount of fluid onto the bottom filter element;
II) detecting a level of cleanliness and providing an output that indicates the level of cleanliness; and then
III) using the output to determine whether to repeat step I.

39. Applicant hereby elects identified group I (now claims 21-29) drawn to a filter house and cleaning system arrangement, with traverse. The method of claim 38, further including the step of providing a pulse of compressed air to the top and bottom filter elements before step I.

40. The method of claim 38, further including the step of providing a pulse of compressed air to the top and bottom filter elements after step III.
